(19) United States
(12) Patent Application Publication
(10) Pub. No.: US 2023/0342587 A1
(43) Pub. Date: Oct. 26, 2023

(54) ONTOLOGY CHANGE GRAPH PUBLISHING SYSTEM

(71) Applicant: Optum, Inc., Minnetonka, MN (US)

(72) Inventors: Daniel G. McCreary, St. Louis Park, MN (US); Jeffrey L. Winkler, Hamel, MN (US)

(21) Appl. No.: 17/660,143

(22) Filed: Apr. 21, 2022

(51) Int. Cl. G06N 3/04; G06N 3/08

(52) U.S. Cl. CPC G06N 3/0427; G06N 3/08

(57) ABSTRACT

A method comprising: generating, by a computing system, a change graph that represents a change to an ontology graph; generating, by the computing system, an impact score for the change graph by applying at least one of a deterministic rule and a machine learning technique to the change graph; and outputting, by the computing system, the change graph and the impact score for the change graph to a subscriber system.

### TECHNICAL FIELD

The disclosure relates to updating information stored in computing systems.

### BACKGROUND

Many computing systems use knowledge graphs (also referred to as “ontology graphs”) to store information. Ontology graphs may illustrate interactions and relationships between various users, concepts, systems, and the like. Users may use ontology graphs to locate the desired entities within the computing system. Each individual entity in the ontology graph may be represented with a node and the relationships between entities may be represented with an edge. Large ontology graphs may have large numbers of nodes (e.g., millions or billions of nodes) and the relationships between the nodes may be very complex.

### SUMMARY

In general, the present disclosure describes techniques for a computing system to determine the potential impact of changes in an ontology graph and to output updates containing the changes to subscriber systems of the ontology graph. The computing system may generate a change graph illustrating the changes to an ontology graph. The computing system may determine the potential impact of the changes by using deterministic rules and/or by applying a machine learning technique (e.g., using a graph machine learning model) to the change graph. The computing system may also represent the potential impact of the changes as an impact score. The computing system may publish the change graph and the impact score of the change graph to one or more subscriber systems, e.g., via one or more publishing systems. In some examples, the computing system may selectively publish the change graph and impact score to the publisher systems and the subscriber systems based on subscribed specialties of each subscriber system.

The techniques of this disclosure may provide one or more technical advantages. By applying deterministic rules and machine learning techniques to the change graph, the techniques of this disclosures may improve computing systems’ ability to measure the impact of changes in the ontology graph to downstream systems, especially in cases where multiple simultaneous changes to the ontology graph may confound the potential impact of any one change. In some examples, by using publishing systems and subscriber systems with specialties, the techniques of disclosure may facilitate retrieval of innovative information from relatively-isolated portions of the ontology graph and share the innovative information to relevant parties without requiring large-scale or complex updates for all users of the ontology graph. In some examples, the techniques of this disclosure may improve the currentness of ontology graphs on the subscriber systems for various specialties by simplifying updating the ontology graphs on the subscriber system.

In some examples, this disclosure describes a method comprising: generating, by a computing system, a change graph that represents a change to an ontology graph; generating, by the computing system, an impact score for the change graph by applying at least one of a deterministic rule and a machine learning technique to the change graph; and outputting, by the computing system, the change graph and the impact score for the change graph to a subscriber system.

In other examples, this disclosure describes a computing system comprising data storage system configured to store an ontology graph; and processing circuitry configured to: generate a change graph that represents a change to an ontology graph; generate an impact score for the change graph by applying at least one of a deterministic rule and a machine learning technique; and output the change graph and the impact score for the change graph to a subscriber system.

In other examples, this disclosure describes a non-transitory computer readable medium comprising instructions that, when executed, cause processing circuitry of a computing system to: generate a change graph that represents a change to an ontology graph; generate an impact score for the change graph by applying at least one of a deterministic rule and a machine learning technique; and output the change graph and the impact score to a subscriber system.

The details of one or more examples are set forth in the accompanying drawings and the description below. Other features, objects, and advantages will be apparent from the description and drawings, and from the claims.

### BRIEF DESCRIPTION OF DRAWINGS

Reference is made to the attached drawings, wherein elements have the same reference numeral designations represent similar elements throughout.

FIG. 1 is a conceptual diagram illustrating an example system for classifying and publishing changes to ontology graphs, in accordance with one or more aspects of the present disclosure.

FIG. 2 is a block diagram illustrating example components of a computing system, in accordance with one or more aspects of the present disclosure.

FIG. 3 is a conceptual diagram illustrating an example process of generating a change graph, in accordance with one or more aspects of the present disclosure.

FIG. 4 is a conceptual diagram illustrating an example process of classifying change graphs using deterministic rules, in accordance with one or more aspects of the present disclosure.

FIG. 5 is a conceptual diagram illustrating an example process of applying a graph convolutional network model to a change graph, in accordance with one or more aspects of the present disclosure.

FIG. 6 is a conceptual diagram illustrating an example user interface displaying the changes and the impact scores for the changes in a change graph, in accordance with one or more aspects of the present disclosure.

FIG. 7 is a flowchart illustrating an example process of outputting a change graph and the impact score to a subscriber system, in accordance with one or more aspects of the present disclosure.

FIG. 8 is a flowchart illustrating an example process for generating an impact score for change graph using deterministic rules, in accordance with one or more aspects of the present disclosure.

FIG. 9 is a flowchart illustrating an example process of generating an impact score for a change graph using a graph convolutional network model, in accordance with one or more aspects of the present disclosure.

### DETAILED DESCRIPTION

The disclosure generally describes devices, systems, and methods for a computing system, or other similar systems (e.g., a cloud computing system), to determine the potential impact of changes in a knowledge graph (also referred to as an “ontology graph”) and outputting updates containing the changes to users of the ontology graph. The computing system may generate a change graph illustrating the changes to an ontology graph. The computing system may determine the potential impact of the changes to an ontology graph and/or other related systems by using deterministic rules and/or by applying a machine learning technique to the change graph. The computing system may publish the change graph and the impact score of the change graph to one or more users (e.g., to subscriber systems of the users), e.g., via one or more publishing systems.

Ontology graphs represent a network of entities (e.g., persons, objects, events, situations, systems, concepts, and the like) and illustrate the relationship between the entities in a graph format. Ontology graphs may be stored in a graph database, e.g., in a computing system, and may be visualized as a graph structure including a plurality of nodes, edges, and labels. Nodes may designate the entities, such as objects or persons within the network. Edges may illustrate relationships between nodes. In some examples, each node or edge may include a label which provides a user additional information regarding the labeled node and/or edge. Ontology graphs may be stored on a computing system in one or more formats including, but are not limited to, Resource Description Format (RDF), Labeled Property Graphs (LPG), Simple Knowledge Organizational System (SKOS), SKOS-XL, and Ontology Web Language (OWL).

In some examples, ontology graphs may graphically represent the network of entities using a plurality of taxonomies. The plurality of taxonomies may operate using custom definitions and distinguishes portions of the network from other portions based on the taxonomy rules. Ontology graphs are commonly used in a variety of industries including, but are not limited to, retail, entertainment, finance, and healthcare industries. In some examples, ontology graphs may facilitate searches and/or investigations within the entities to locate a desired entity based on the input of a user. For example, ontology graphs may be used to determine recommended products, recommended search results, recommended information, and the like. Users of ontology graphs may include employees or customers of an organization. The user may navigate through ontology graphs using simple deterministic rules (e.g., via if-then statements and the like) or by using artificial intelligence techniques (e.g., via natural language processing (NLP)).

In some examples, ontology graphs may be separated into multiple levels (e.g., an upper ontology, a lower ontology, and the like). The lower ontology may represent more specific components of the network and may be specifically tailored to certain processes (e.g., specific documents, specific searches). Changes to the lower ontology may be localized and may only affect a small portion of the ontology graph. The upper ontology may represent more general components of the network (e.g., organizational policies). Changes to the upper ontology may have an impact on large portions of the ontology graph.

In some examples, ontology graphs may be configured such that a copy of the ontology graphs are stored on a user’s computing device. Ontology graphs may be very complex, wherein the ontology graph may have millions to billions of individual nodes. A computing system may update all copies of the ontology graphs by developing and applying a centralized update to all copies of the ontology graph. In some examples, as users make change to their local copies of the ontology graph, it may be difficult for a computing system to retrieve the individual changes and incorporate the changes into the centralized update. In addition, it may be difficult to accurately predict the potential impacts of each individual change in a plurality of changes on related entities in the ontology graph since the plurality of changes may have confounding effects that may be difficult to separate.

The devices, systems, and methods of this disclosure may provide one or more technical advantages over other computing systems. By applying deterministic rules and machine learning techniques to a change graph, the techniques of this disclosures may improve the computing system’s ability to measure the impact of each change on related systems. In addition, the techniques of disclosure may improve the retrieval of relatively-isolated changes within the ontology graph and may facilitate the propagation of the change to relevant users without requiring an update of all copies of the ontology graph. In addition, the techniques of disclosure may be scalable as the size of the ontology graph increases and as such may be applied to much larger ontology graphs and yield similar benefits.

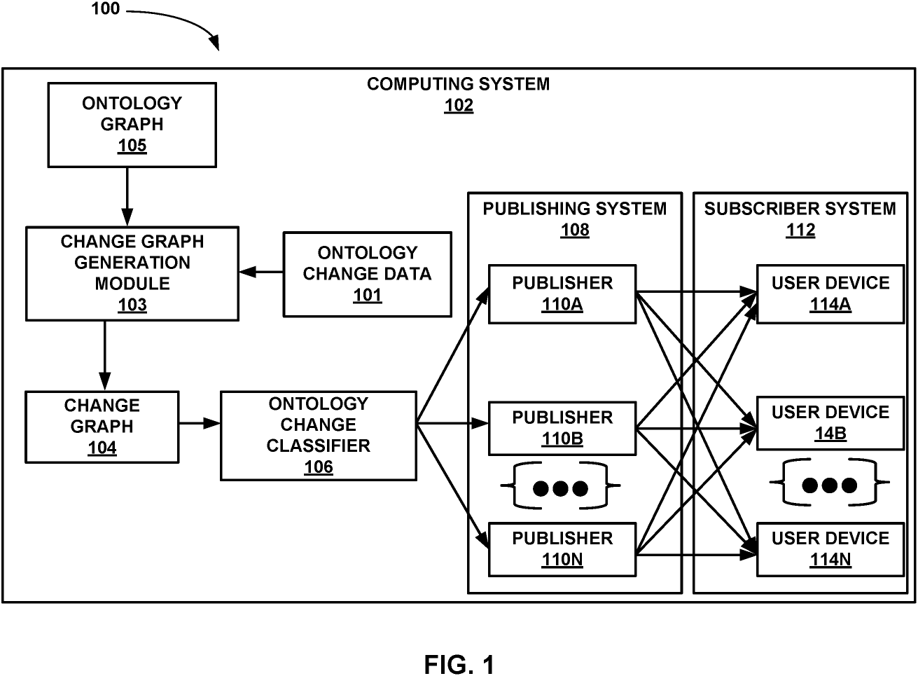

FIG. 1 is a conceptual diagram illustrating an example system 100 for classifying and publishing changes to ontology graphs, in accordance with one or more aspects of the present disclosure. System 100 may include a computing system 102, a change graph generation module 103, an ontology change classifier 106, a publishing system 108, and a subscriber system 112. As illustrated in FIG. 1, computing system 102 includes change graph generation module 103, ontology change classifier 106, publishing system 108, and subscriber system 112. In other examples, system 100 may include computing system 102, change graph generation module 103, ontology change classifier 106, publishing system 108, and subscriber system 112 as separate components. Computing system 102, change graph generation module 103, ontology change classifier 106, publishing system 108, and subscriber system 112 may represent one or more computing systems, computing devices, or in a cloud computing environment.

Computing systems may include any suitable computing system, such as one or more desktop computers, mainframes, servers, cloud computing systems, etc. Computing devices may include, but are not limited to, mobile phones (including smart phones) laptop computers, tablet computers, desktop computers, servers, mainframes, and the like.

Computing system 102 provides change graph 104 to ontology change classifier 106. change graph 104 may indicate one or more changes, e.g., made by a user, to a copy of the ontology graph (hereinafter referred to as “ontology graph 105”). A user may make changes to a local copy of ontology graph 105 using web-based local-publishing workflows, an application, or in another way. The changes may include, but are not limited to, addition/deletion of nodes, addition/deletion of edges, movement of nodes, movement of edges, modification to a node, modification to an edge, modification to a label, modification to links between ontology graph 105 and other ontology graphs, and the like.

In some examples, computing system 102 obtains data representing the one or more changes to ontology graph 105 (herein referred to as “ontology change data 101”) by comparing a changed copy of ontology graph 105 to a reference copy of ontology graph 105 stored in computing system 102. In some examples, computing system 102 may obtain ontology change data 101 by analyzing metadata of the changed copy of ontology graph 105. In some examples, computing system 102 may obtain ontology change data 101 when computing system 102 receives a notification (e.g., via one of user devices 114A-N) that the user has made one or more changes to ontology graph 105.

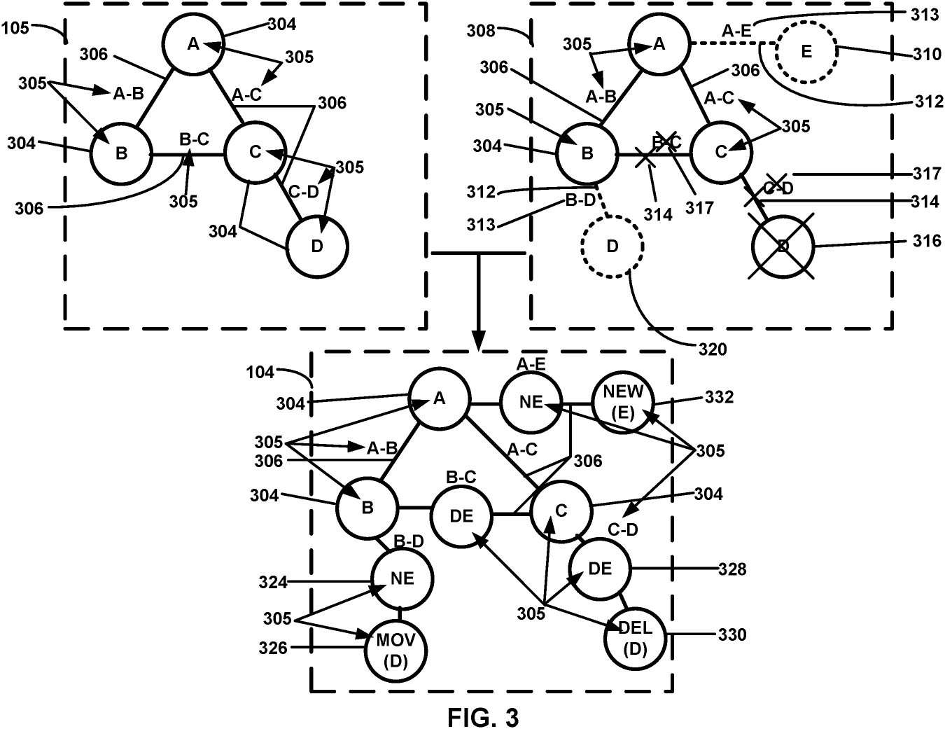

Computing system 102 generates change graph 104 based on ontology change data 101 and ontology graph 105, e.g., via change graph generation module 103. An example process of generating change graph 104 is described below with regard to FIG. 3. Computing system 102 may provide change graph 104 to ontology change classifier 106. In some examples, change graph 104 may also be referred to as an ontology delta graph (ODG).

Ontology change classifier 106 may apply one or more deterministic rules (e.g., one or more isomorphic graph queries) and/or one or more machine learning techniques to change graph 104 to determine the potential impact of the one or more changes to ontology graph 105 indicated by change graph 104. The potential impact of a change to the ontology graph may include effects on nodes, edges, and labels in ontology graph 105 that are linked to the changes, effects on systems and other entities downstream of the changes, and/or effects on other ontology graphs linked to ontology graph 105.

Ontology change classifier 106 may generate an impact score based on change graph 104. The impact score provides a numerical representation of the potential impact of the one or more changes to the ontology graph 105 indicated by change graph 104. In some examples, ontology change classifier 106 may generate the impact score by accounting for the quantity of changes and location of changes indicated by change graph 104. For example, changes in an upper ontology of ontology graph 105 may be given greater weight than changes in a lower ontology of ontology graph 105. For example, the impact score may be between a value of 1 and 100, with a score of 1 indicating very little impact to ontology graph 105 and a score of 100 indicating significant impact across a large portion of ontology graph 105. In some examples, ontology change classifier 106 may also assign an impact label to the change to the ontology graph based on the determined impact score. The impact labels may include, but are not limited to, “trivial”, “small”, “medium”, “large”, “severe,” or the like. For example, ontology change classifier 106 may assign an impact label of “trivial” to an impact score of between 1 and 20.

Ontology change classifier 106 may provide change graph 104, the impact score, and/or the impact label to publishers (e.g., publishers 110A-N, collectively referred to as “publishers 110”) of publishing system 108. Publishing system 108 may include one or more publishers 110. Each of publishers 110 may be a computer module configured to provide a common forum for computing system 102 (e.g., ontology change classifier 106 of computing system 102) to communicate with one or more user devices 114 A-N (collectively referred to as “user devices 114”) without requiring direct communications channels between computing system 102 and the one or more user devices 114. Each of publishers 110 may be configured to post information regarding a particular specialty. The posted information may then be retrieved by one or more user devices 114 of subscriber system 112 who have subscribed to the particular specialty. In some examples, each of publishers 110 correspond to a particular specialty that uses at least a portion of ontology graph 105 and may be configured to publish and/or transmit updates corresponding to the particular specialty of publishers 110. In some examples, each of publishers 110 may have a single specialty or may have two or more specialties. Computing system 102 and/or users may create publishers 110 and designate one or more specialties for each of publishers 110. Users of ontology graph 105 may create publishers 110 using user devices 114. The specialties of each of publishers 110 may correspond to the one or more taxonomies used to organize ontology graph 105. Computing system 102 may retrieve change graph 104, the impact scores, and/or the impact labels from ontology change classifier 106 and transmit change graph 104, the impact scores, and/or the impact labels to publishers 110 whose specialties contain portions of ontology graph 105 that may be impacted by the one or more changes in change graph 104. In some examples, computing system 102 may transmit change graph 104, the impact scores, and/or the impact labels to publishing system 108, which may then transmit the change graph 104, the impact scores, and/or the impact labels to applicable publishers 110 within publishing system 108. In some examples, computing system 102 may select one of a plurality of publishing systems 108 and transmit change graph 104, the impact scores, and/or the impact labels to the selected publishing system based on the specialties of the publishers 110 within the selected publishing system. In other words, computing system 102 may select, based on a determination that the change is relevant to a specialty of a first publishing system of publishing system 108, the first publishing system from publishing systems 108. The selected publishing system may then publish change graph 104, the impact scores for change graph 104, and/or the impact labels for change graph 104 to subscriber system 112. Publishing system 108 may determine whether the specialty of each of publishers 110 may be impacted based on the metadata of change graph 104. In some examples, computing system 102, publishing system 108, and subscriber system 112 may be part of a single memory stream. In a single memory stream, computing system 102 may transmit information (e.g., change graph 104, the impact scores, and/or the impact labels), subscriber system 112 (e.g., user devices 114 of subscriber system 112) may retrieve the information, and publishing system 108 (e.g., publishers 110 of publishing system 108) may provide a common forum for computing system 102 to transmit the information to and for subscriber system 112 to retrieve the information from. Using a single memory stream, computing system 102 may not require the use of dedicated communications channels to user devices 114 to transmit change graph 104, the impact scores, and/or the impact labels to user devices 114. In some examples, one or more of publishers 110 may publish the received information (e.g., change graph 104, the impact scores, and/or the impact labels) by making the received information available for retrieval by any subscribed user devices 114 and by transmitting to the subscribed user devices 114 an indication that the one or more of publishers 110 has received the information. In some examples the transmitted indication may include metadata containing the impact scores and/or the impact labels,

Computing system 102 may instruct publishing system 108 to transmit change graph 104 to user devices 114 of subscriber system 112 based on the subscriptions of each of user devices 114. Each of user devices 114 may be a computing system and/or computing device used by users to access one or more downstream systems (e.g., consumer-facing systems, recommendation systems, or the like) through ontology graph 105. User devices 114 may include, but is not limited to, portable or mobile devices such as mobile phones (including smart phones), laptop computers, tablet computers, wearable computing devices such as smart watches or computerized eyewear, smart television platforms, cameras, personal digital assistants (PDAs), etc. In some examples, user devices 114 may include stationary computing devices such as desktop computers, servers, mainframes, etc. User devices 114 may be configured to retrieve information (e.g., change graph 104, the impact scores, and/or the impact labels) from one or more publishers 110 of publishing system 108. Each of user devices 114 may be used by a user (e.g., employee, customer) to interact with computing system 102. Each of user devices 114 of subscriber system 112 may subscribe to one or more publishers 110 of publishing system 108 based on the specialties of each of publishers 110. For each respective publisher (e.g., publisher 110A) of publishers 110, computing system 102 may instruct the publisher 110A to transmit the received change graph 104, the impact scores, and/or the impact labels to each of user devices 114 that has an active subscription to the publisher 110A. In some examples, user devices 114 may be configured to retrieve change graph 104, the impact scores, and/or the impact labels from one or more publishers 110 based on an indication, e.g., from the one or more publishers 110, that the one or more publishers 110 received new information and/or data from computing system 102.

In some examples, publishing system 108 may transmit to subscriber system 112 in response to an instruction from computing system 102. In some examples, publishing system 108 may compare the impact score to a threshold impact score and may automatically publish any change graph 104 with an impact score lower than the threshold impact score to subscriber system 112 and hold all other change graph 104 until publishing system 108 receives an instruction from computing system 102 to publish. In some examples, publishing system 108 may hold change graph 104 until publishing system 108 receives requests from subscriber system 112 and/or one or more user devices 114 to transmit to user devices 114. In some examples publishing system 108 may automatically transmit metadata of change graph 104 to one or more user devices 114, where the metadata contains at least the impact score and/or impact label of change graph 104, and the one or more user devices 114 of subscriber system 112 may automatically request publishing system 108 publish change graph 104 if the impact score contained in the metadata is below a threshold impact score. In some examples, computing system 102 may transmit change graph 104, the impact scores, and/or the impact labels directly to subscriber system 112 and/or user devices 114.

After each of user devices 114 receive change graph 104, the impact scores, and/or the impact labels, each of user devices 114 may choose to update the local copy of ontology graph 105 stored on user devices 114 to include changes represented in change graph 104. In some examples, user devices 114 may choose to accept some of the changes represented in change graph 104 and reject other changes represented in change graph 104. In some examples, subscriber system 112 may notify computing system 102 of which changes each of user devices 114 have accepted, if any, and the current versions of the copies of ontology graph 105 of each of user devices 114.

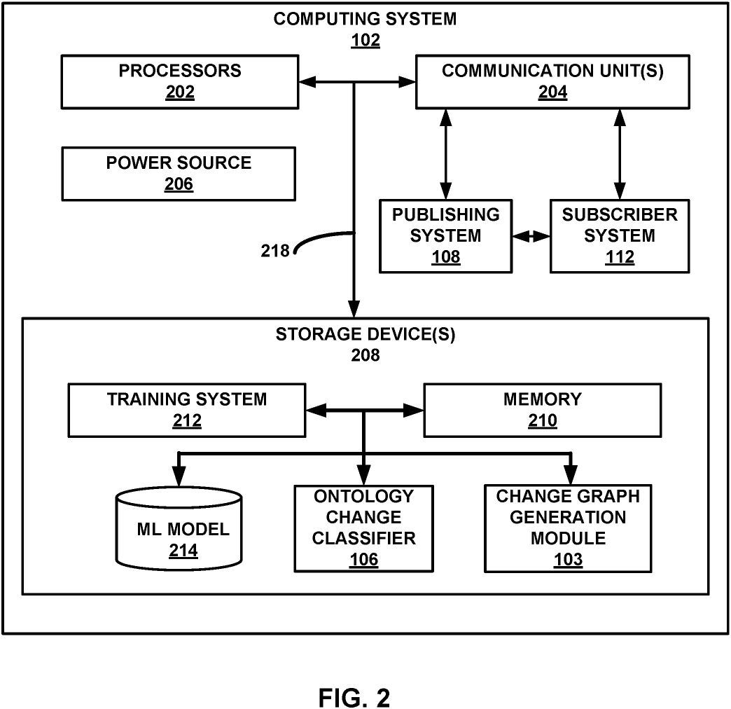

FIG. 2 is a block diagram illustrating example components of computing system 102, in accordance with one or more aspects of the present disclosure. FIG. 2 illustrates only one particular example of computing system 102, and many other examples of computing system 102 may be used in other instances and may include a subset of the components included in example computing system 102 or may include additional components not shown in the example of FIG. 2. In some examples, the components of computing system 102 may be located within a single computing device. In other examples, the components of computing system 102 may be located across a plurality of computing devices.

Computing system 102 may include one or more processors 202, one or more communication unit(s) 204, publishing system 108, subscriber system 112, one or more storage device(s) 208, power source 206, and communications channels 218. Storage device(s) 208 may include training system 212, machine learning (ML) model 214, ontology change classifier 106, and memory 210. Communications channels 218 may interconnect at least some of the components 202, 204, 108, 112, and 208 for inter-component communications (physically, communicatively, and/or operatively). In some examples, communications channels 218 may include a system bus, a network connection, one or more inter-process communication data structures, or any other components for communicating data between hardware and/or software.

One or more processors 202 may implement functionality and/or execute instructions within computing system 102. For example, processors 202 of computing system 102 may receive and execute instructions stored by storage devices 208 that provide the functionality of training system 212, ML model 214, change graph generation module 103, ontology change classifier 106, publishing system 108, and subscriber system 112. These instructions executed by processors 202 may cause computing system 102 to store and/or modify information within storage devices 208 during program execution. Processors 202 may execute instructions to training system 212, ML model 214, change graph generation module 103, ontology change classifier 106, publishing system 108, and subscriber system 112 to perform one or more operations. That is, training system 212, ML model 214, change graph generation module 103, ontology change classifier 106, publishing system 108, and subscriber system 112 may be operable by processors 202 to perform various functions described herein.

One or more communication units 204 of computing system 102 may communicate with external devices by transmitting and/or receiving data. For example, computing system 102 may use communication units 204 to transmit and/or receive ontology change data 101, change graph 104, ontology graph 105, the impact scores, the impact labels, or the like between computing system 102 and one or more external computing systems and/or computing devices.

Storage devices 208 includes memory 210 configured to store information. In some examples, memory 210 includes temporary memory and is configured for short-term storage of information. In some examples, temporary memory of memory 210 may be a volatile memory and may note retain stored contents if deactivated. Examples of volatile memories include random access memories (RAM), dynamic random access memories (DRAM), static random access memories (SRAM), and other forms of volatile memories known in the art. In some examples memory 210 may be configured to store metadata of change graph 104, ontology graph 105, and/or ontology change data 101 in memory 210.

Memory 210 may also include one or more computer-readable storage media configured to store larger amounts of information than temporary memory of memory 210 and for a longer amount of time. Memory 210 may be further configured for long-term storage of information as non-volatile memory space and retain information after activate/off cycles. Non-volatile memories may include magnetic hard discs, optical discs, flash memories, or forms of electrically programmable memories (EPROM) or electrically erasable and programmable (EEPROM) memories. In some examples, computing system 102 may store ontology graph 105, ontology change data 101, change graph 104, change graphs of past ontology changes, and the impact scores and impact labels of the change graphs into non-volatile memory of memory 210.

Storage devices 208 and memory 210 may store program instructions and/or data associated with training system 212, ML model 214, ontology change classifier 106, publishing system 108, and subscriber system 112. Training system 212 may be configured to train ML model 214 for use in ontology change classifier 106. Training system 212 may train ML model 214 using a dataset including the change graphs, impact scores, and impact labels of past ontology changes. Once training system 212 finishes training ML model 214, computing system 102 may transmit ML 214 to ontology change classifier 106 for use in determining the potential impact of change graph 104.

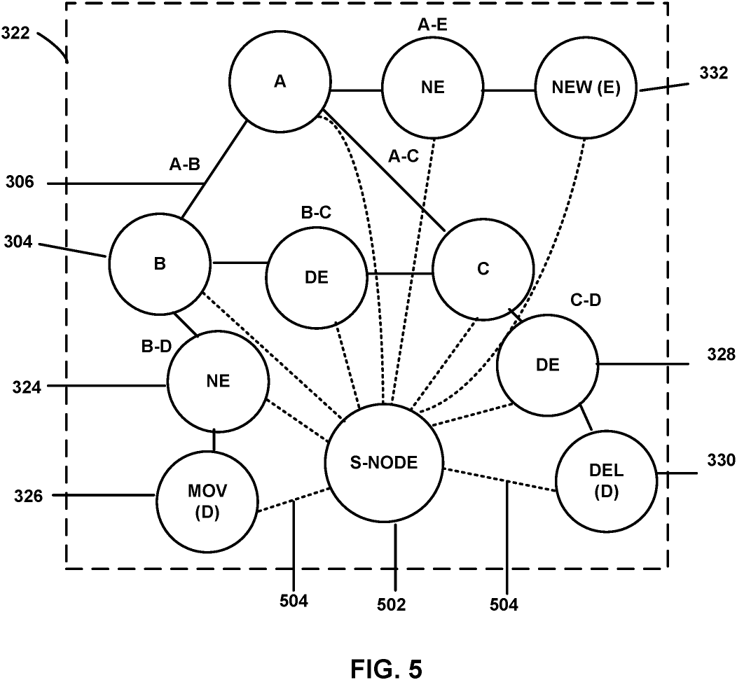

ML model 214 may be a graph machine learning model including, but is not limited to, logistical regression, graph convolutional networks (GCN), and the like. In some examples, computing system 102 may apply the graph machine learning model to a dataset comprising change graph 104. In some examples, the graph machine learning model may comprise GCN, and computing system 102 may apply the graph machine learning model to the dataset using the GCN to perform a graph classification technique on the dataset. GCNs may perform graph classification using a neural network model. As part of performing graph classification, ontology change classifier 106 may aggregate feature vector values for each node in change graph 104 and for a special node in change graph 104 (e.g., S-node of FIG. 5), to determine an input vector and applying a neural network model to the input vector to generate an output vector. The output vector may be the impact scores of the changes of change graph 104. GCN may include the use of one or more models including, but are not limited, Node2Vec, FastRP, and GraphSage.

In some examples training system 212 may train a GCN of ML model 214 to perform a classification analysis, e.g., graph classification analysis, on change graph 104. Training system 212 may train the GCN by training the neural network model of the GCN. The neural network model may determine relationships within a dataset (e.g., the nodes, edges, and labels of change graph 104). The neural network model may contain an input layer, one or more hidden layers, and an output layer. Training system 212 may train the neural network model using a dataset containing known input values and corresponding output values. In some examples, training system 212 of computing system 102 may train the neural network for the neural network model based on a dataset comprising a plurality of past change graphs (i.e., change graphs of past ontology changes) and impact scores of the plurality of past change graphs. The dataset may include the past change graphs as known input values and the corresponding impact scores as known output values. Training system 212 may use random inputs for the one or more hidden layers until the error rates for the determined output values of the neural network model for a plurality of known input and output values are within an acceptable error threshold (e.g., about 5 percent or less).

FIG. 3 is a conceptual diagram illustrating an example process of generating a change graph 104, in accordance with one or more aspects of the present disclosure. The example method of FIG. 3 may be performed by a computing system (e.g., computing system 102), an ontology change classifier (e.g., ontology change classifier 106), or any other appropriate device and/or system.

Ontology graph 105 contains a plurality of nodes 304 and edges 306 linking each of nodes 304 to one or more other nodes 304. Each of nodes 304 and edges 306 also include a label 305. As illustrated in ontology graph 105 of FIG. 3, labels 305 may indicate a designation for each of nodes 304 and edges 306. For example, a label 305 of “B” on a node 304 indicates that the node 304 has a designation of “node B” in ontology graph 105. In another example, a label 305 of “A-B” on an edge 306 indicates that the edge 306 connects node A with node B, as illustrated in FIG. 3. In other examples label 305 may contain additional information or other information including, but is not limited to, the entity type (e.g., document, person, system, and the like), the date of creation, applicable definitions, and the like.

Ontology graph 308 illustrates a plurality of changes made to ontology graph 105, e.g., by a user. The changes to ontology graph 105 may include the insertion of new nodes (e.g., node 310), insertion of new edges (e.g., edge 312), and/or insertion of new labels (e.g., label 313). The changes to ontology graph 105 may also include the deletion of nodes (e.g., node 316), deletion of edges (e.g., edges 314), and deletion of labels (e.g., label 317). The changes to ontology graph 105 may also include movement of nodes (e.g., node 320) and movement of labels (not pictured). Computing system 102 may determine that a change to ontology graph 105 is a movement of nodes or labels based on a determination that the one or more nodes 304 and/or labels 305 in ontology graph 308 are connected to a different set of nodes 304 than in ontology graph 105. In some examples, ontology graph 308 may also include modification of nodes, edges, and/or labels (not pictured). Modifications may include changes in the text, metadata, or other information of one or more nodes 304, edges 306, and/or labels 305.

Computing system 102, change graph generation module 103, or any applicable device and/or system as described herein, may generate a change graph 104 which illustrates the changes made to ontology graph 105 that are illustrated in ontology graph 308. Computing system 102 may compare ontology graph 105 to ontology graph 308 and identify changes between ontology graph 105 and ontology graph 308. Computing system 102 may insert, for each change in change graph 104, a node corresponding to the change into change graph 104. Change graph 104 may represent each change made to a node 304, edge 306, or label 305 as a node. In some examples, computing system 102 may attach a node property label to the inserted node indicating the type of the change. For example, a new node inserted to ontology graph 105 in ontology graph 308 may be represented by node 332, which may include a label 305 of “New (E)” which indicates the type of change (“New” for “new node”) and/or the designation of the inserted node (“E” for “node E”). As illustrated in change graph 104, new nodes, new edges (“NE”), deleted notes (“DEL”), deleted edges (“DE”), moved nodes (“MOV”), moved edges (not pictured), and moved labels (not pictured) may all be represented as a node in change graph 104 (e.g., nodes 324, 326, 328, 330). Change graph 104 may be used, e.g., by ontology change classifier 106, to determine a predicted severity level of each of the changes on one or more downstream systems or entities and/or other portions of ontology graph 105. The predicted severity level may correspond to the potential impact of each of the changes on one or more downstream systems and the magnitude of the potential impact. Downstream systems of ontology graph 105 may include, but are not limited, question-and-answer systems, recommendation systems, investigation systems, consumer-facing search systems, or the like.

In some examples, computing system 102 may generate change graph 104 by applying a graph embedding analysis on ontology graph 105 and on ontology graph 308 and comparing the graph embedding vector of the ontology graph 105 and the graph embedding vector of ontology graph 308. Graph embedding vectors may be a lower-dimensional representation of a graph in a vector space. Each graph embedding vector may include a vector of numbers associated with one or more nodes of a graph and/or a portion of the graph. In a graph embedding analysis, computing system 102 may performs one or more random walks on a graph (e.g., change graph 104, ontology graph 105, ontology graph 308, or the like) around a single node in the graph to characterize the structure of the graph and transform the graph into a vector representation of the graph (a graph embedding vector) that retains the structure and other characteristics of the graph. Computing system 102, ontology change classifier 106, and other applicable devices and systems may then the perform any of the techniques discussed herein by using the graph embedding vectors as a mathematical representation of graphs. In some examples, computing system 102 may generate graph embedding vectors using Bidirectional Encoder Representations from Transformers (BERT), Generative Pre-trained Transformer 3 (GPT), or other similar language models.

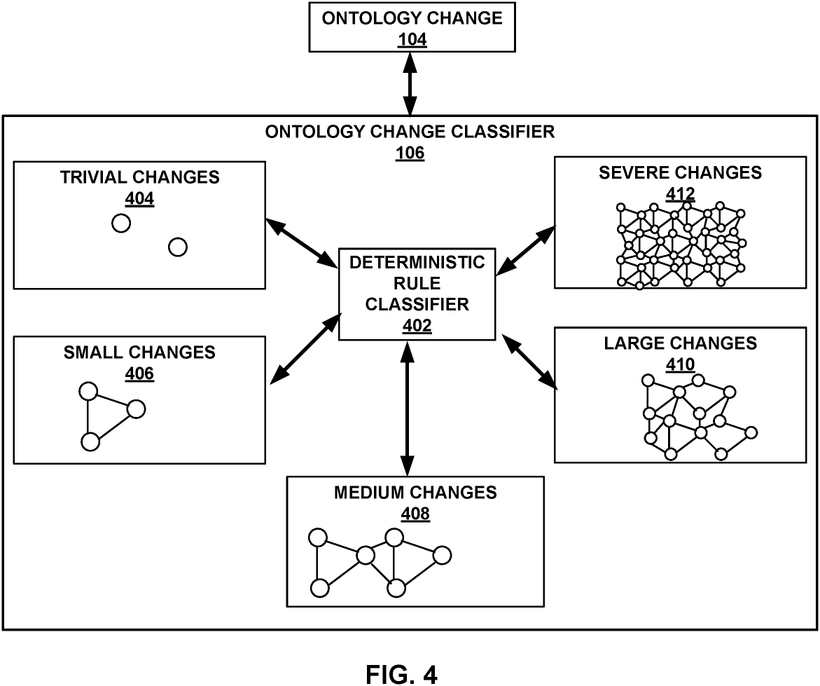

FIG. 4 is a conceptual diagram illustrating an example process of classifying change graph 104 using deterministic rules, in accordance with one or more aspects of the present disclosure. As illustrated in FIG. 4, ontology change classifier 106 may classify change graph 104 using deterministic rules. In other examples, the classification of FIG. 4 may be performed other applicable devices and/or systems.

Ontology change classifier 106 receives change graph 104 from computing system 102, e.g., from change graph generation module 103. Ontology change classifier 106 may apply a deterministic rule classifier 402 to determine the potential impact of change graph 104. Deterministic rule classifier 402 determines a number of instances of a particular attribute of change graph 104 and compares the number to a number of instances of the same attribute in ontology graph 105 to determine a difference value for the attribute. The attributes may include, but are not limited to, the number of nodes (e.g., nodes 304, 332), the total number of edges (e.g., edges 306 in the graph), the total number of nodes, edges, and/or labels (e.g., node labels, edge labels) that have been added and/or removed (e.g., nodes 324, 328, 330, 332, and the like), the total number of nodes, edges, and/or labels that have been moved (e.g., node 326), the total number of changed labels and the number of links to external ontologies graphs that have been changed. For example, if change graph 104 has 5 nodes 304, 326, and 332 and ontology graph 105 has 4 nodes 304, then change graph 104 has a difference value of 1 for the attribute of the number of nodes.

Deterministic rule classifier 402 may compare the difference value for one or more attributes of change graph 104 with the difference value for the same one or more attributes of past change graphs to determine an appropriate impact score and/or impact label for change graph 104. For example, deterministic rule classifier 402 may compare the difference value for the number of nodes of change graph 104 with the difference value for the number of nodes of past change graphs and assign an impact score and/or impact label to change graph 104 based on the comparison. If the difference values for change graph 104 is relatively close to the difference value for a past change graph, then deterministic rule classifier 402 may assign change graph 104 a substantially similar impact value as the past change graph. In some examples, deterministic rule classifier 402 may assign change graph 104 into one of the plurality of groups 404-412 based on the impact score of change graph 104 and assign an impact label to change graph 104 based on the assigned group. The plurality of groups (e.g., “Trivial Changes” 404, “Small Changes” 406, “Medium Changes 408”, “Large Changes 410”, and “Severe Changes 412”) may encompass a range of impact scores and include past change graphs with impact scores that fall within the range of each group. For example, if deterministic rule classifier 402 assigns change graph 104 into the “Medium Changes” group 408, deterministic rule classifier 402 may also assign change graph 104 an impact label of “Medium.”

FIG. 5 is a conceptual diagram illustrating an example process of applying a graph convolutional network (GCN) model to change graph 104, in accordance with one or more aspects of the present disclosure. Computing system 102 may place a special node 502 (“S-node”) within change graph 104, e.g., during generation of change graph 104, which is linked to every other node (e.g., nodes 304, 324, 326, 328, 330, 332) of change graph 104 by edges 504. Computing system 102 and/or ontology change classifier 106 may determine a feature vector for each node of change graph 104 and a feature vector for special node 502. Each feature vector may be an array of values corresponding to the location of each node, e.g., relative to special node 502. Computing system 102 and/or ontology change classifier 106 may then aggregate the feature vectors to determine an aggregation vector for change graph 104. Computing system 102 may determine the aggregation vector by applying an algorithm to change graph 104. The aggregation vector may be a single combined feature vector that describes the entire change graph 104. Computing system 102 may apply the algorithm by aggregating the feature vectors of each node of change graph 104 around special node 502 and updating the feature vector of special node 502 using the aggregation vector (e.g., by summing the feature vector of special node 502 with the aggregation vector). The updated feature vector of special node 502 may then be inputted into a neural network model to generate an output vector for change graph 104, e.g., in a process as previously discussed in the disclosure. Output vector may include an array of values corresponding to the changes of change graph 104. In some examples, each value of the array of values may be the impact score of a change in change graph 104. In some examples, computing system 102 may assign the output vector for change graph 104 as an updated feature vector for special node 502 and apply the algorithm to change graph 104 for a second time.

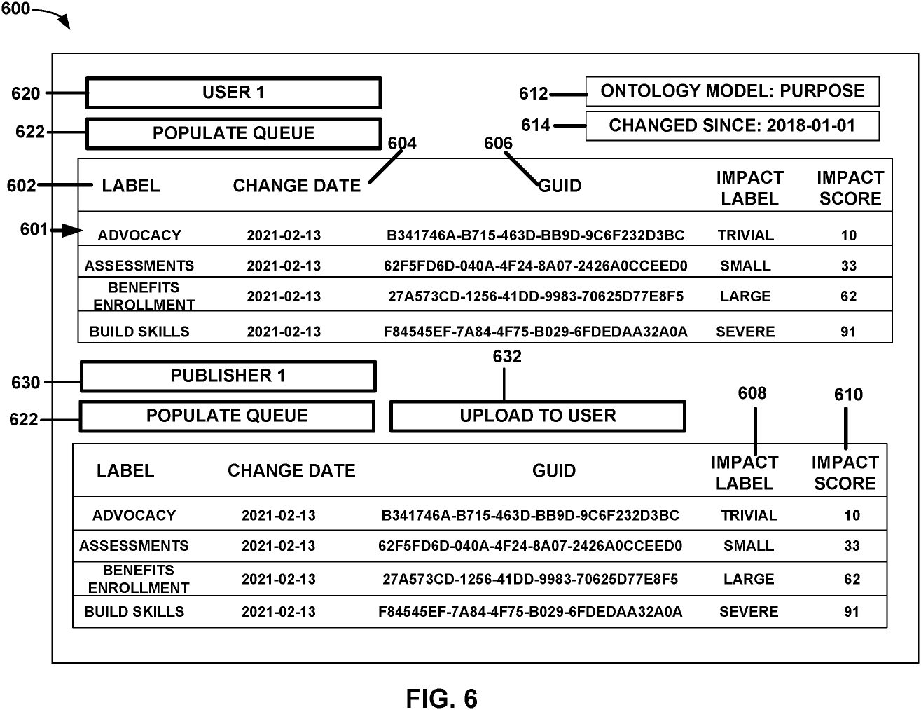

FIG. 6 is a conceptual diagram illustrating an example user interface (UI) 600 displaying changes 601 and the impact score 610 for each change in change graph 104, in accordance with one or more aspects of the present disclosure. UI 600 may display one or more changes 601, the designation of ontology graph 105, and a date of the last change 614 to ontology graph 105. UI 600, as illustrated in FIG. 6, includes a user UI 620 and a publisher UI 630. User UI 620 and Publisher UI 630 may include a “populate queue” function 622 to retrieve potentially relevant changes 601 from publishing system 108 and/or ontology change classifier 106. Publisher UI 630 may include a “publish to subscribers” function 632 to publish changes 601 in Publisher UI 630 to subscriber system 112.

For each of changes 601, UI 600 may display metadata including, but is not limited to, a label 602, a change date 604, identifier 606, impact label 608, and impact score 610. Computing system 102 may generate UI 600 for display to publishers 110 and/or user devices 114. Publishers 110 and/or user devices 114 may choose to publish or accept changes 601, respectively, based on the metadata of the changes 601.

Label 602 may indicate the one or more specialties (e.g., advocacy, assessments, benefits enrollment, build skills, etc.) that one or more of changes 601 is relevant to. In some examples, as illustrated in FIG. 6, label 602 may indicate a single specialty. In other examples, label 602 may indicate two or more specialties. Identifier 606 may be used to identify each of changes 601 within computing system 102. Identifier 606 may be a globally unique identifier (GUID), or any other identification system known in the art.

In some examples, computing system 102 may only generate user UI 620 and publisher UI 630 for user devices 114 and publishers 110, respectively. Computing system 102 may pre-populate user UI 620 and/or publisher UI 630 with changes 601. In other examples, computing system 102 populates user UI 620 and publisher UI 630 in response to input from one or more user devices 114 and one or more publishers 110, respectively, (e.g., based on a determination that one or more user devices 114 and/or one or more publishers 110 selected the “populate queue” function 622).

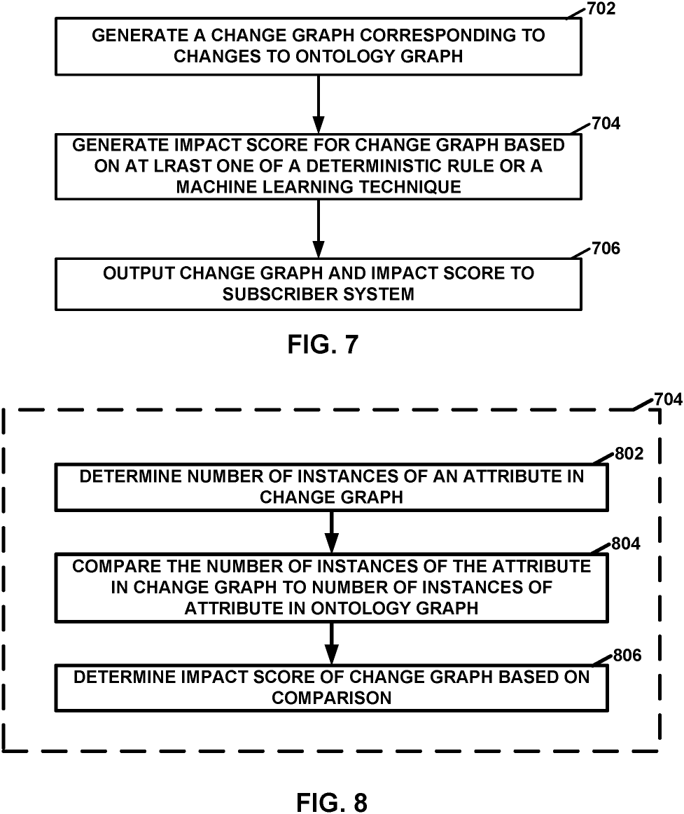

FIG. 7 is a flowchart illustrating an example process of outputting a change graph (e.g., change graph 104) and the impact score (e.g., impact score 610) to a subscriber system 112, in accordance with one or more aspects of the present disclosure. A computing system (e.g., computing system 102) may generate a change graph 104 corresponding to changes to ontology graph 105 (702). Computing system 102 may generate change graph 104 in accordance with the one or more of the example methods described with regard to FIG. 3. For example, computing system 102 may generate change graph 104 by performing a graph embedding analysis on ontology graph 105 and on ontology graph 308 and comparing the graph embedding vectors of ontology graph 105 and ontology graph 308.

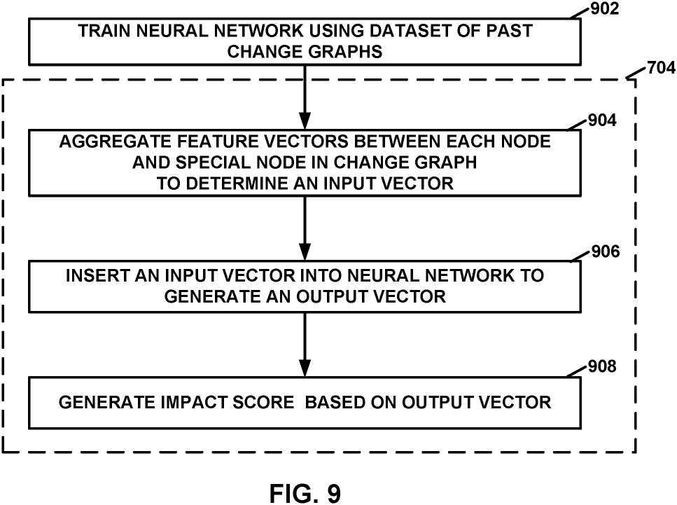

Computing system 102 may generate impact score 610 for change graph 104 by applying at least one of a deterministic rule or a machine learning (ML) technique (704). Computing system 102 may apply deterministic rules, ML techniques, or both depending on the complexity of change graph 104. In some examples, computing system 102 may only apply deterministic rules to change graph 104 if the change graph 104 is relatively simple with a lower number of changes. An example process of generating impact score 610 based on deterministic rules is described below with respect to FIG. 8. In some examples, computing system 102 may apply ML techniques to change graph 104 if the ontology change is relatively complex with a higher number of changes. An example process of generating impact score 610 based on ML techniques is described below with respect to FIG. 9.

Computing system 102 may output change graph 104 and impact score 610 to subscriber system 112 (706). In some examples, computing system 102 may first transmit change graph 104 and impact score 610 to a publishing system 108 and then output change graph 104 and impact score 610 to subscriber system 112 using publishing system 108. In some examples, computing system 102 may output change graph 104 and impact score 610 directly to subscriber system 112, e.g., based on a determination that change graph 104 impacts one or more of user devices 114 of subscriber system 112 and impact score 610 does not exceed a threshold impact score. In some examples, computing system 102 may output change graph 104 and impact score 610 to subscriber system 112 based on the subscriptions of user devices 114 within subscriber system 112.

FIG. 8 is a flowchart illustrating an example process for generating an impact score 610 for a change graph 104 using deterministic rules, in accordance with one or more aspects of the present disclosure. The steps of the example method of FIG. 8 may be performed as a part of step 704 of the example process of FIG. 7.

Computing system 102 may determine a number of instances of an attribute in change graph 104 (802). In some examples, computing system 102 may determine the number of instances of two or more attributes in change graph 104. Attributes in change graph 104 may include, but are not limited to, the number of nodes (e.g., nodes 304, 332), the number of edges (e.g., edges 306 in the graph), the number of nodes, edges, and/or labels that have been added and/or removed (e.g., nodes 324, 328, 330, 332, and the like), the number of nodes, edges, and/or labels that have been moved (e.g., node 326), and the number of links to external ontologies graphs that have been changed, and the like.

Computing system 102 may compare the number of instances of the attribute in change graph 104 to the number of instances of the same attribute in ontology graph 105 (804). In some examples, computing system 102 may determine, for each attribute, a difference value between the number of instances in change graph 104 and ontology graph 105.

Computing system 102 may determine impact score 610 of change graph 104 based on the comparison (806). Computing system 102 may compare the difference value between the number of instances in change graph 104 and ontology graph 105 with the difference values of past change graphs and assign impact score 610 based on how change graph 104 compares relative to the past change graphs. In some examples, impact score 610 may be weighed based on the location of the changes in change graph 104 within ontology graph 105 (e.g., in the upper ontology versus the lower ontology).

FIG. 9 is a flow chart illustrating an example method of generating an impact score 610 for a change graph 104 using a graph convolutional network (GCN) model, in accordance with one or more aspects of the present disclosure. At least some of the steps of the example method of FIG. 9 (e.g., steps 904-908) may be performed as a part of step 704 of the example method of FIG. 7.

Computing system 102 may train a neural network using a dataset of past change graphs (902). In some examples computing system 102 may train the neural network model using a known input dataset (e.g., a past change graph) and a known output dataset (e.g., the impact score of the past change graph) from the dataset of past change graphs. Computing system 102 may initially seed one or more weight and/or bias values of the one or more hidden layers of the neural network with random values. Computing system 102 may then insert inputs (e.g., a past change graph) from the known input dataset into the neural network to generate an error function. Computing system 102 may determine the error rate of the neural network using the error function. Computing system 102 may iteratively adjust the one or more weight and/or bias values of the neural network to converge the calculated outputs from the neural network with the known output dataset. Computing system 102 may iteratively adjust one or more of the weight and/or bias values of the neural network until the error rate is below an acceptable value (e.g., 5 percent or less). In some examples, computing system 102 may change the error function of the neural network model if the calculated outputs do not converge with the known output dataset.

Computing system 102 may aggregate feature vectors of nodes 304 of change graph 104 to determine an input vector (904). The input vector may be the updated feature vector of special node 502 of change graph 104. Computing system 102 may aggregate feature vectors of nodes 304 to determine an aggregation vector and update the feature vector of special node 502 using the aggregation vector in a manner previously discussed in the disclosure.

Computing system 102 may insert input vector into a neural network to generate an output vector (906). Output vector may include an array of values, each of which may correspond to the impact score of a change in change graph 104. Computing system 102 may generate impact score 610 based on output vector (908). In some examples, each value of the array of values of output vector may directly represent impact score 610 of change graph 104. In some examples, Computing system 102 may convert output vector to impact score 610 based on the past output vectors of past change graphs.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, “Device” or “devices” may include a plurality of hardware appliances configured to receive telecommunications from one or more other parties. The hardware appliances include, but are not limited to, cellphones, smartphones, tablets, laptops, personal computers, smartwatches. In other examples, “Device” or “devices” may include the use of a browser to communicate with one or more other devices.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage medium which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some respects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

The following is a non-limiting list of examples that are in accordance with one or more aspects of this disclosure.

Example 1: a method comprising: generating, by a computing system, a change graph that represents a change to an ontology graph; generating, by the computing system, an impact score for the change graph by applying at least one of a deterministic rule and a machine learning technique to the change graph; and outputting, by the computing system, the change graph and the impact score for the change graph to a subscriber system.

Example 2: the method of example 1, wherein generating the impact score comprises applying the machine learning technique to the change graph, and wherein applying the machine learning technique to the change graph comprises applying a graph machine learning model to a dataset comprising the change graph.

Example 3: the method of any of examples 1 and 2, wherein the graph machine learning model comprises a graph convolutional network, and wherein applying the graph machine learning model to the dataset comprises using the graph convolutional network to perform a graph classification technique on the dataset.

Example 4: the method of example 3, further comprising: wherein using the graph convolutional network to perform the graph classification technique on the dataset comprises performing the graph classification technique using a neural network model; and the method further comprises training, by the computing system, a neural network for the neural network model based on a dataset comprising a plurality of past change graphs and impact scores of the plurality of past change graphs.

Example 5: the method of any of examples 1-4, wherein generating the impact score comprises applying the deterministic rule, and wherein applying the deterministic rule comprises: determining, by the computing system, a number of instances of an attribute in the change graph; comparing, by the computing system, the number of instances of the attribute in the change graph to a second number of the attribute in the ontology graph; and determining, by the computing system, the impact score based on the comparison.

Example 6: the method of example 5, wherein the attribute comprises one or more of a number of nodes, a total number of edges, a total number of changed node labels, a total number of moved node labels, or a number of changes to external links between the ontology graph and one or more other ontology graphs.

Example 7: the method of any of examples 1-6, wherein generating the change graph comprises: comparing, by the computing system, the ontology graph with an updated ontology graph; identifying, by the computing system, the change between the ontology graph and the updated ontology graph.

Example 8: the method of any of examples 1-7, wherein: the method further comprises selecting, based on a determination that the change is relevant to a specialty of a first publishing system of a plurality of publishing systems of the computing system, the first publishing system from the plurality of publishing systems; and wherein publishing the change graph and the impact score for the change graph comprises publishing, by the first publishing system, the change graph and the impact score for the change graph to the subscriber system.

Example 9: the method of any of examples 1-8, wherein outputting the change graph and the impact score for the change graph to the subscriber system comprises outputting the change graph to the subscriber system based on a determination, by the computing system, that the change impacts the subscriber system and that the impact score for the change graph does not exceed a threshold impact score.

Example 10: the method of any of examples 1-9, wherein generating the change graph comprises: applying, by the computing system, a graph embedding analysis on the ontology graph and an updated ontology graph comprising the change; and comparing, by the computing system, a graph embedding vector of the ontology graph and a graph embedding vector of the updated ontology graph.

Example 11: the method of any of examples 1-10, wherein the impact score corresponds to a predicted severity level of the change on one or more systems downstream of the ontology graph.

Example 12: a computing system comprising: data storage system configured to store an ontology graph; and processing circuitry configured to: generate a change graph that represents a change to the ontology graph; generate an impact score for the change graph by applying at least one of a deterministic rule and a machine learning technique; and output the change graph and the impact score for the change graph to a subscriber system.

Example 13: the computing system of example 12, wherein to generate the impact score for the change graph, the processing circuitry is configured to apply the machine learning technique to the change graph, and wherein to apply the machine learning technique to the change graph, the processing circuitry is further configured to apply a graph machine learning model to a dataset comprising the change graph.

Example 14: the computing system of any of examples 12 and 13, wherein the graph machine learning model comprises a graph convolutional network, and wherein to apply the graph machine learning model to the dataset, the processing circuitry is configured to perform a graph classification technique on the dataset using the graph convolutional network.

Example 15: the computing system of any of examples 12-14, wherein to generate the impact score for the change graph, the processing circuitry is configured to apply the deterministic rule, and wherein to apply the deterministic rule, the processing circuitry is further configured to: determine a number of instances of an attribute in the change graph; compare the number of instances of the attribute in the change graph to a second number of instances of the attribute in the ontology graph; and determine the impact score based on the comparison.

Example 16: the computing system of any of examples 12-15, wherein to generate the change graph, the processing circuitry is further configured to: compare the ontology graph with an updated ontology graph; identify the change between the ontology graph and the updated ontology graph; insert a node in the ontology graph, wherein the node corresponds to the change; and attach a node property label to the node indicating a type of the change.

Example 17: the computing system of any of examples 12-16, wherein the processing circuitry is further configured to select, based on a determination that the change is relevant to a specialty of a first publishing system of a plurality of publishing systems of the computing system, the first publishing system from the plurality of publishing systems, and wherein to publish the change graph and the impact score for the change graph, the processing circuitry is further configured to publish, through the first publishing system, the change graph and the impact score for the change graph to the subscriber system.

Example 18: a non-transitory computer readable medium comprising instructions that, when executed, cause processing circuitry of a computing system to: generate a change graph that represents a change to an ontology graph; generating an impact score for the change graph by applying at least one of a deterministic rule and a machine learning technique; and output the change graph and the impact score to a subscriber system.

Example 19: the non-transitory computer readable medium of example 18, comprising instructions, that when executed, cause processing circuitry to generate the impact score for the change graph by applying the machine learning technique, and wherein to apply the machine learning technique the processing circuitry is configured to apply a graph convolutional network to a dataset comprising the change graph.

Example 20: the non-transitory computer readable medium of any of examples 18 and 19, wherein the to apply the deterministic rules to the change graph to output the impact score, the instructions cause processing circuitry to: determine a number of instances of an attribute in the change graph; compare the number of instances of the attribute in the change graph to a second number of instances of the attribute in the ontology graph; and determine the impact score based on the comparison.

What is claimed is:

1. A method comprising:
generating, by a computing system, a change graph that represents a change to an ontology graph;
generating, by the computing system, an impact score for the change graph by applying at least one of a deterministic rule and a machine learning technique to the change graph; and
outputting, by the computing system, the change graph and the impact score for the change graph to a subscriber system.

2. The method of claim 1, wherein generating the impact score comprises applying the machine learning technique to the change graph, and wherein applying the machine learning technique to the change graph comprises applying a graph machine learning model to a dataset comprising the change graph.

3. The method of claim 2, wherein the graph machine learning model comprises a graph convolutional network, and wherein applying the graph machine learning model to the dataset comprises using the graph convolutional network to perform a graph classification technique on the dataset.

4. The method of claim 3, further comprising:
wherein using the graph convolutional network to perform the graph classification technique on the dataset comprises performing the graph classification technique using a neural network model; and
the method further comprises training, by the computing system, a neural network for the neural network model based on a dataset comprising a plurality of past change graphs and impact scores of the plurality of past change graphs.

5. The method of claim 1, wherein generating the impact score comprises applying the deterministic rule, and wherein applying the deterministic rule comprises:
determining, by the computing system, a number of instances of an attribute in the change graph;
comparing, by the computing system, the number of instances of the attribute in the change graph to a second number of instances of the attribute in the ontology graph; and
determining, by the computing system, the impact score based on the comparison.

6. The method of claim 5, wherein the attribute comprises one or more of a number of nodes, a total number of edges, a total number of changed node labels, a total number of moved node labels, or a number of changes to external links between the ontology graph and one or more other ontology graphs.

7. The method of claim 1, wherein generating the change graph comprises:
comparing, by the computing system, the ontology graph with an updated ontology graph;
identifying, by the computing system, the change between the ontology graph and the updated ontology graph;
inserting, by the computing system, a node into the change graph, wherein the node corresponds to the change; and
attaching, by the computing system, a node property label to the node indicating a type of the change.

8. The method of claim 1, wherein:
the method further comprises selecting, based on a determination that the change is relevant to a specialty of a first publishing system of a plurality of publishing systems of the computing system, the first publishing system from the plurality of publishing systems, and
wherein publishing the change graph and the impact score for the change graph comprises publishing, by the first publishing system, the change graph and the impact score for the change graph to the subscriber system.

9. The method of claim 1, wherein outputting the change graph and the impact score for the change graph to the subscriber system comprises outputting the change graph to the subscriber system based on a determination, by the computing system, that the change impacts the subscriber system and that the impact score for the change graph does not exceed a threshold impact score.

10. The method of claim 1, wherein generating the change graph comprises:
applying, by the computing system, a graph embedding analysis on the ontology graph and an updated ontology graph comprising the change; and
comparing, by the computing system, a graph embedding vector of the ontology graph and a graph embedding vector of the updated ontology graph.

11. The method of claim 1, wherein the impact score corresponds to a predicted severity level of the change on one or more systems downstream of the ontology graph.

12. A computing system comprising:
data storage system configured to store an ontology graph; and
processing circuitry configured to:
generate a change graph that represents a change to the ontology graph;
generate an impact score for the change graph by applying at least one of a deterministic rule and a machine learning technique; and
output the change graph and the impact score for the change graph to a subscriber system.

13. The computing system of claim 12, wherein to generate the impact score for the change graph, the processing circuitry is configured to apply the machine learning technique to the change graph, and wherein to apply the machine learning technique to the change graph, the processing circuitry is further configured to apply a graph machine learning model to a dataset comprising the change graph.

14. The computing system of claim 13, wherein the graph machine learning model comprises a graph convolutional network, and wherein to apply the graph machine learning model to the dataset, the processing circuitry is configured to perform a graph classification technique on the dataset using the graph convolutional network.

15. The computing system of claim 12, wherein to generate the impact score for the change graph, the processing circuitry is configured to apply the deterministic rule, and wherein to apply the deterministic rule, the processing circuitry is further configured to:
determine a number of instances of an attribute in the change graph;
compare the number of instances of the attribute in the change graph to a second number of instances of the attribute in the ontology graph; and
determine the impact score based on the comparison.

16. The computing system of claim 12, wherein to generate the change graph, the processing circuitry is further configured to:
compare the ontology graph with an updated ontology graph;
identify the change between the ontology graph and the updated ontology graph;
insert a node in the ontology graph, wherein the node corresponds to the change; and
attach a node property label to the node indicating a type of the change.

17. The computing system of claim 12, wherein:
the processing circuitry is further configured to select, based on a determination that the change is relevant to a specialty of a first publishing system of a plurality of publishing systems of the computing system, the first publishing system from the plurality of publishing systems, and
wherein to publish the change graph and the impact score for the change graph, the processing circuitry is further configured to publish, through the first publishing system, the change graph and the impact score for the change graph to the subscriber system.

18. A non-transitory computer readable medium comprising instructions that, when executed, cause processing circuitry of a computing system to:
generate a change graph that represents a change to an ontology graph;
generating an impact score for the change graph by applying at least one of a deterministic rule and a machine learning technique; and
output the change graph and the impact score to a subscriber system.

19. The non-transitory computer readable medium of claim 18, comprising instructions, that when executed, cause processing circuitry to generate the impact score for the change graph by applying the machine learning technique, and wherein to apply the machine learning technique the processing circuitry is configured to apply a graph convolutional network to a dataset comprising the change graph.

20. The non-transitory computer readable medium of claim 18, wherein the to apply the deterministic rules to the change graph to output the impact score, the instructions cause processing circuitry to:
determine a number of instances of an attribute in the change graph;
compare the number of instances of the attribute in the change graph to a second number of instances of the attribute in the ontology graph; and
determine the impact score based on the comparison.
